(19) United States
(12) Patent Application Publication
(10) Pub. No.: US 2019/0368880 A1
(43) Pub. Date: Dec. 5, 2019

(54) NAVIGATION METHOD BASED ON WAYSIDE REFERENCE OBJECT MATCHING

(71) Applicant: NIO NEXTEV LIMITED, Hong Kong (CN)

(72) Inventor: Xiang MA, Shanghai (CN)

(21) Appl. No.: 16/462,793

(22) PCT Filed: Jul. 28, 2017
(86) PCT No.: PCT/CN2017/095038

§ 371 Date: May 21, 2019

(30) Foreign Application Priority Data
Nov. 21, 2016 (CN) 201611049020.3

(51) Int. Cl. G01C 21/20

(52) U.S. Cl. CPC G01C 21/20; B60L 53/30

(57) ABSTRACT

The invention provides a navigation method and in particular a navigation method based on wayside reference object matching. In order to realize navigation in places that are not covered with GPS or BeiDou navigation signals, the navigation method based on wayside reference object matching comprises the steps of: acquiring navigation information based on at least one wayside reference object in a first trip (S210); searching in a second trip for a base point matched with any of the at least one wayside reference object (S220); and using the navigation information to navigate when the base point matched with any of the at least one wayside reference object is found (S230). In the application scenario of a parking lot, the navigation method can realize the navigation for a vehicle searching person in a parking lot without GPS or BeiDou navigation coverage, thereby improving the vehicle searching person's efficiency in finding the vehicle.

### TECHNICAL FIELD

The invention relates to a navigation method and in particular to a navigation method based on wayside reference object matching.

### BACKGROUND ART

In the prior art, in-vehicle navigation has been widely used. Generally, the in-vehicle navigation realizes real-time locating of a vehicle based on the GPS satellite positioning system; and guides a driver or passenger in real time with regard to the driving direction and route selection according to a calculated route to the destination based on the correlation between the real-time position and the map. However, for vehicles driving in an indoor parking lot, in-vehicle navigation equipment (a navigator or mobile phone) cannot receive GPS signals and thus fails to fulfill fine-grained navigation tasks inside the parking lot. In other words, how to realize navigation in places that are not covered with GPS or BeiDou navigation signals is a problem that needs to be solved currently.

In addition, in valet charging services, the efficiency of a service delivery person in finding the user's vehicle is one of the key factors that determine the time consumption of the service. When a vehicle is parked indoors (such as in an indoor parking lot) without GPS coverage, how the service person efficiently finds the vehicle parked by the user is a difficulty in the operation of the valet charging service. Therefore, if navigation can be realized in places that are not covered with GPS or BeiDou navigation signals, the efficiency of the service person in finding the user's vehicle will be greatly improved.

Based on this, the field needs a new navigation method to solve the above problems.

### SUMMARY OF THE INVENTION

In order to solve the above-mentioned problem in the prior art, that is, to realize navigation in places that are not covered with GPS or BeiDou navigation signals, the invention provides a navigation method based on wayside reference object matching. The method comprises the steps of: acquiring navigation information based on at least one wayside reference object in a first trip; searching in a second trip for a base point matched with any of the at least one wayside reference object; and using the navigation information to navigate when the base point matched with any of the at least one wayside reference object is found.

In a preferred embodiment of the above navigation method, the at least one wayside reference object comprises a plurality of wayside reference objects, and the navigation information comprises a position of each of the plurality of wayside reference objects and a first navigation path between the plurality of wayside reference objects.

In a preferred embodiment of the above navigation method, the first navigation path comprises a first adjacency navigation path between the adjacent wayside reference objects and a first non-adjacency navigation path between the nonadjacent wayside reference objects.

In a preferred embodiment of the above navigation method, the navigation information also comprises a second navigation path from each of the plurality of wayside reference objects to a destination.

In a preferred embodiment of the above navigation method, the step of searching in a second trip for a base point matched with any of the at least one wayside reference object further comprises: searching in the second trip for the same wayside reference object as any of the wayside reference objects.

In a preferred embodiment of the above navigation method, the step of using the navigation information to navigate further comprises: using the first navigation path to navigate.

In a preferred embodiment of the above navigation method, the step of using the navigation information to navigate also comprises: using the second navigation path and/or the first non-adjacency navigation path to navigate, if the wayside reference object matched with a certain wayside reference object in the first trip cannot be found in the second trip during navigation with the first adjacency navigation path.

In a preferred embodiment of the above navigation method, the navigation method is a navigation method for a vehicle, and the wayside reference objects are license plates of roadside vehicles during a trip of the vehicle to the destination.

In a preferred embodiment of the above navigation method, the first trip is the trip of the vehicle to the destination, and the second trip is the trip of a subject required to reach the destination.

In a preferred embodiment of the above navigation method, the step of acquiring navigation information based on at least one wayside reference object in a first trip comprises: during the trip of the vehicle to the destination, photographing the license plates of the roadside vehicles for the first time at a predetermined frequency; and/or determining a navigation path between the roadside vehicles; and/or determining a navigation path from the roadside vehicle to the destination.

In a preferred embodiment of the above navigation method, the step of searching in a second trip for a base point matched with any of the at least one wayside reference object comprises: in the process of the subject required to reach the destination heading to the destination, photographing the license plates of the roadside vehicles for the second time; and searching the license plates obtained during the photographing for the second time for the same license plates as the license plates obtained during the photographing for the first time.

In a preferred embodiment of the above navigation method, the vehicle is an electric vehicle, and the subject is a service person who delivers a valet charging service.

In the technical solution of the invention, for example, in a parking lot that is not covered by GPS or BeiDou navigation, it is impossible to use GPS or BeiDou navigation to directly navigate a vehicle searching person to a destination, in which case, by acquiring navigation information based on at least one wayside reference object in a first trip (e.g., a trip of a vehicle to the destination) and searching in a second trip (e.g., a trip for a vehicle searching person to find a vehicle) for a base point matched with the at least one wayside reference object, navigation for the second trip is realized by inertial navigation. That is to say, the navigation for a vehicle searching person is realized in a parking lot without GPS or BeiDou navigation coverage, thereby improving the vehicle searching person's efficiency in finding the vehicle. In addition, when the invention is used in a parking lot, vehicles (license plate numbers) in the parking lot can be taken as a reference object, so adequate reference objects can be acquired in the application scenario of a parking lot, thereby greatly improving the navigation accuracy.

### BRIEF DESCRIPTION OF THE DRAWINGS

FIG. 1 is a basic schematic diagram of a navigation method based on wayside reference object matching of the invention;

FIG. 2 is a basic flow chart of the navigation method based on wayside reference object matching of the invention; and

FIG. 3 is a basic flow chart of one of the embodiments of the invention.

### DETAILED DESCRIPTION OF EMBODIMENTS

Preferred embodiments of the invention are described below with reference to the accompanying drawings. It should be understood by those skilled in the art that these embodiments are only for explaining the technical principles of the invention and are not intended to limit the scope of protection of the invention. For example, although the present application is described in connection with the scenario where a service person of a valet charging service searches for a vehicle in an underground parking lot, it is obvious that the technical solution of the invention is not intended to be limited to such application, and the technical solution of the invention can be flexibly applied to other navigation scenarios where there is no access to navigation signals by those skilled in the art without departing from the technical principle of the invention.

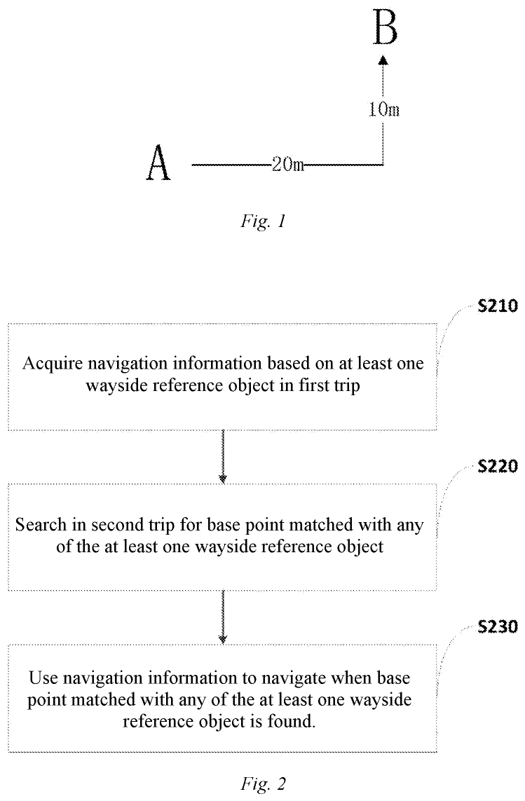

The basic navigation principle of the invention is, with a preset reference point, calculating the position of a subject relative to the reference point based on the displacement of the subject relative to the reference point. For example, as shown in FIG. 1, a reference point A is preset in advance, the position of the subject is B, and the position B relative to the reference point A moves eastward (rightward in FIG. 1) by 20 meters and then northward (upward in FIG. 1) by 10 meters. In this case, when the subject at B needs to be found, the reference point A can be found first, then the subject can be found by moving eastward by 20 meters and then northward by 10 meters from the reference point A.

In a practical application scenario, taking a vehicle as an example, after the vehicle sets off from the reference point A, the driving path data such as the distance traveled in each straight line and the steering angle along the route need to be recorded until the vehicle travels to the position B. Thus, an owner of the vehicle can send a vehicle searching person the route information from the reference point A to the position B recorded during the driving of the vehicle. After the vehicle searching person finds the reference point A, the vehicle located at the position B can be found according to the route information sent by the vehicle owner along the same route as with the route information.

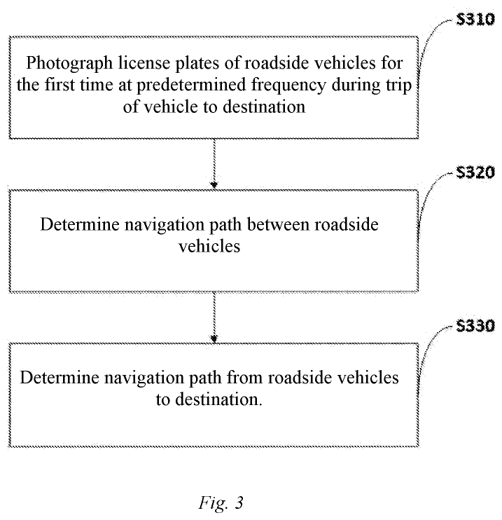

Based on the above principle, as shown in FIG. 2, the navigation method based on wayside reference object matching of the invention mainly comprises the following steps: at S210, acquiring navigation information based on at least one wayside reference object in a first trip; at S220, searching in a second trip for a base point matched with any of the at least one wayside reference object; and at S230, using the navigation information to navigate when the base point matched with any of the at least one wayside reference object is found.

Through the navigation method of the invention, vehicles parked in underground parking lots can be found quickly. In this embodiment, an example of finding a vehicle parked in an underground parking lot will be described. At S110, the first trip is the trip of the vehicle to the destination (i.e., the parking space where the vehicle is finally parked); and at S120, the second trip is the trip of a subject required to reach the destination (in this embodiment, the subject refers to a vehicle searching person, specifically, a service person for valet charging). At S130, in the process of vehicle searching by the vehicle searching person (i.e., in the second trip), the vehicle searching person finds a reference matched with the wayside reference object acquired by the vehicle in the first trip, preferably the same reference object as the wayside reference object acquired by the vehicle in the first trip, and the vehicle searching person is navigated according to the navigation information of the reference object. In other words, the most efficient path for the second trip is the same path as the first trip. In addition, the navigation information based on the wayside reference objects may comprise the position of each wayside reference object and a first navigation path between the wayside reference objects, and may also comprise a second navigation path from each of the wayside reference objects to the destination. More specifically, the first navigation path can particularly comprise a first adjacency navigation path between the adjacent wayside reference objects and a first non-adjacency navigation path between the nonadjacent wayside reference objects. As an example, when using the navigation information to navigate, the vehicle searching person may first use the first adjacency navigation path for navigation, and when a certain wayside reference object in the first trip cannot be found, for example, a vehicle is driven away, the second navigation path and/or the first non-adjacency navigation path may be alternatively used for navigation, which is described in detail hereinafter.

Due to the problem of data precision, the further the position B from the reference point A, the greater the error of the calculated path, that is, the greater the deviation of the second trip from the first trip. Therefore, the more wayside reference objects acquired in the first trip, the less the deviation of the second trip from the first trip. In this embodiment, since there are adequate vehicles parked in the parking lot, in order to obtain enough wayside reference objects, the vehicles parked in the parking lot (specifically, the license plate number of each vehicle) can be selected as the wayside reference objects.

In this embodiment, as shown in FIG. 3, the step of acquiring navigation information based on license plate numbers in the first trip comprises the following substeps:

At S310, during the trip of the vehicle to the destination, the license plates of the roadside vehicles are photographed for the first time at a predetermined frequency. Specifically, the predetermined frequency can be rationally selected according to the actual size of the parking lot (for example, photographing every 5 s, 10 s, 15 s, etc.). Moreover, the license plates of the roadside vehicles can be photographed by a vehicle-mounted camera. In this embodiment, the captured images of the license plates can be processed and the license plate number of each license plate can be acquired for distinguishing different vehicles. Because every license plate number is unique (each license plate number corresponds to one vehicle), the license plate numbers can be used as reference points in the driving path of the vehicle and recorded as license plate number C1, license plate number C2, license plate number C3, . . . , and license plate number Cn. At S320, a navigation path between the roadside vehicles is determined. At S330, a navigation path from each of the roadside vehicles to the destination is determined.

For example, at S320, position information of each roadside vehicle may be selectively determined before determining a navigation path between the roadside vehicles. Specifically, since each license plate number corresponds to one vehicle, the license plate number can be regarded as a vehicle. Therefore, the position information of the roadside vehicles can be regarded as information of the relative positions between license plate number C1, license plate number C2, license plate number C3, . . . , and license plate number Cn, for example, the relative position of license plate number C2 with respect to license plate number C1 (for example, C2 is located 20 meters east and 10 meters north of C1), the relative position of license plate number C3 with respect to license plate number C2, and so on, up to the relative position of license plate number Cn with respect to license plate number Cn−1. Accordingly, at S320, the navigation path between the roadside vehicles comprises two types of navigation path, that is, a first adjacency navigation path between the adjacent reference objects and a first non-adjacency navigation path between the nonadjacent reference objects. More specifically, the first adjacency navigation path comprises, for example, a navigation path between license plate number C2 and license plate number C1, a navigation path between license plate number C3 and license plate number C2, and so on, up to a navigation path between license plate number Cn and license plate number Cn−1; and the first non-adjacency navigation path may be a path between any nonadjacent reference objects, such as a navigation path between license plate number C3 and license plate number C1, a navigation path between license plate number C6 and license plate number C3, etc. Of course, the navigation path between the roadside vehicles may alternatively comprise only the navigation path between the adjacent reference objects. At S330, the navigation path from the roadside vehicles to the destination, i.e., the second navigation path, comprises a navigation path from license plate number C1 to the destination, a navigation path from license plate number C2 to the destination, . . . , a navigation path from license plate number Cn to the destination, etc.

In this embodiment, after the vehicle owner parks the vehicle at the destination (the final parking space), since there is no network in the underground parking lot, an on-board computer can first send the navigation information to a mobile phone of the vehicle owner or other fellow passengers through an in-vehicle network. After the vehicle owner or passengers leave the parking lot, the first navigation path and the second navigation path acquired in the first trip are uploaded through the mobile phone to a server or other relay equipment which sends the first navigation path and the second navigation path to the vehicle searching person. Alternatively, after parking the vehicle at the destination, the vehicle owner or other fellow passengers may directly send the first navigation path and the second navigation path acquired in the first trip to the vehicle searching person. In the second trip, the vehicle searching person searches for the same license plate number as the reference point license plate number C1, license plate number C2, license plate number C3, . . . , license plate number Cn. When the same license plate number is found, the vehicle can be found in the second trip according to the first navigation path and/or the second navigation path, and the most efficient path of the second trip is the same path as the first trip.

For example, in the second trip, the vehicle searching person photographs the license plates of the roadside vehicles, in which case the license plate of every roadside vehicle can be photographed, for example, images of the license plates of all vehicles along the route can be captured by a self-contained camera, then the captured images of the license plates are processed, and the license plate number Tn of each license plate is acquired. The acquired license plate number Tn is compared with the license plate number C1, license plate number C2, license plate number C3, . . . , and license plate number Cn acquired during the photographing for the first time, so as to find the same license plate number as any of license plate number C1, license plate number C2, license plate number C3, . . . , and license plate number Cn. When the same license plate number is found for the first time, for example, when license plate number T1 same as license plate number C1 is found, the vehicle searching person is navigated to the position of license plate number C2 along the path from license plate number C1 to license plate number C2, and then license plate number T2 same as license plate number C2 is found, the vehicle searching person is thus navigated to the position of license plate number C3 along the path from license plate number C2 to license plate number C3, and so on, until the vehicle searching person is navigated to the position of the destination according to the first navigation path.

For example, when the vehicle searching person is navigated to the position of license plate number C2 along the path from license plate number C1 to license plate number C2, and the vehicle searching person does not find license plate number T2 same as license plate number C2, the first adjacency navigation path can be switched to the second navigation path. That is, when license plate number T2 same as license plate number C2 is not found, the vehicle searching person drives according to the navigation path from license plate number C1 to the destination until the same license plate number as another of license plate number C1, license plate number C2, license plate number C3, . . . , and license plate number Cn is found during driving, switches to the first adjacency navigation path again, and follows the above-mentioned method until being navigated to the position of the destination. Alternatively, when the vehicle searching person is navigated to the position of license plate number C2 and does not find license plate number T2 same as license plate number C2, the first adjacency navigation path can be switched to the first non-adjacency navigation path. For example, when the license plate number T2 same as the license plate number C2 is not found, the vehicle searching person can follow the navigation path from license plate number C1 to license plate number C3 (or license plate numbers C4, C5, etc.). Correspondingly, when license plate number T3 is present, it is possible to switch back to the first adjacency navigation path again, that is, resume the navigation by following the path from license plate number C3 to license plate number C4, unless another license plate number later cannot be matched again.

As an example, in order to help a vehicle searching person to quickly find a reference point, an initial reference point may be set at the entrance of the parking lot, that is, the initial position of the first trip is the entrance of the parking lot, and then navigation information based on a plurality of license plate numbers may be acquired at a predetermined frequency in the first trip. During vehicle searching, the initial position of the second trip is also the entrance of the parking lot, the vehicle searching person searches in the second trip for the license plate numbers acquired in the first trip, and then drives according to the first navigation path or the second navigation path to finally reach the destination.

It should be noted that in this embodiment, the navigation method is used to search for a vehicle in a parking lot. In most cases, the interval between a user parking a vehicle and a vehicle searching person searching for the vehicle will not be very long. Therefore, the probability of data mismatch caused by a vehicle serving as a reference object being retrieved is not very high, thus ensuring the continuity of navigation in the vehicle searching process. In addition, even if the reference objects cannot be matched in the vehicle searching process, navigation can be resumed by switching the navigation path (for example, switching from the first adjacency navigation path to the first non-adjacency navigation path or the second navigation path), thus further ensuring the continuity of navigation.

The navigation method can be used for valet charging services, that is, a user of an electric vehicle acquires navigation information for a plurality of wayside reference objects during parking, a service person who delivers the valet charging service searches for a reference point matched with the wayside reference objects, and navigates by using the navigation information until reaching the destination and finding the electric vehicle parked by the user.

In addition, it should be noted that when the navigation information for the wayside reference objects is uploaded to the server, if there is access to network signals in the parking lot, the vehicle directly uploads the navigation information for the wayside reference objects to the server; and if there is no access to network signals in the parking lot, the vehicle transmits the navigation information for the wayside reference objects to the user's mobile phone through the in-vehicle network, and then the user uploads the navigation information for the wayside reference objects to the server or directly sends it to the service person who delivers the valet charging service through the mobile phone at a place where there is access to network signals.

Heretofore, the technical solutions of the invention have been described with reference to the preferred embodiments shown in the accompanying drawings; however, those skilled in the art can readily understand that the protection scope of the invention is obviously not limited to these particular embodiments. Without departing from the principle of the invention, a person skilled in the art may make equivalent modifications or substitutions to related technical features, and the technical solutions after these modifications or substitutions shall fall within the scope of protection of the invention.

What is claimed is:

1. A navigation method based on wayside reference object matching, the method comprising the steps of:
acquiring navigation information based on at least one wayside reference object in a first trip;
searching in a second trip for a base point matched with any of the at least one wayside reference object; and
using the navigation information to navigate when the base point matched with any of the at least one wayside reference object is found.

2. The navigation method based on wayside reference object matching according to claim 1, wherein the at least one wayside reference object comprises a plurality of wayside reference objects, and the navigation information comprises a position of each of the plurality of wayside reference objects and a first navigation path between the plurality of wayside reference objects.

3. The navigation method based on wayside reference object matching according to claim 2, wherein the first navigation path comprises a first adjacency navigation path between the adjacent wayside reference objects and a first non-adjacency navigation path between the nonadjacent wayside reference objects.

4. The navigation method based on wayside reference object matching according to claim 3, wherein the navigation information also comprises a second navigation path from each of the plurality of wayside reference objects to a destination.

5. The navigation method based on wayside reference object matching according to claim 4, wherein the step of searching in a second trip for a base point matched with any of the at least one wayside reference object further comprises: searching in the second trip for the same wayside reference object as any of the wayside reference objects.

6. The navigation method based on wayside reference object matching according to claim 5, wherein the step of using the navigation information to navigate further comprises: using the first adjacency navigation path to navigate.

7. The navigation method based on wayside reference object matching according to claim 6, wherein the step of using the navigation information to navigate also comprises: using the second navigation path and/or the first non-adjacency navigation path to navigate, if the wayside reference object matched with a certain wayside reference object in the first trip cannot be found in the second trip during navigation with the first adjacency navigation path.

8. The navigation method based on wayside reference object matching according to claim 1, wherein the navigation method is a navigation method for a vehicle, and the wayside reference objects are license plates of roadside vehicles during a trip of the vehicle to the destination.

9. The navigation method based on wayside reference object matching according to claim 8, wherein the first trip is the trip of the vehicle to the destination, and the second trip is the trip of a subject required to reach the destination.

10. The navigation method based on wayside reference object matching according to claim 9, wherein the step of acquiring navigation information based on at least one wayside reference object in a first trip comprises:
during the trip of the vehicle to the destination, photographing the license plates of the roadside vehicles for the first time at a predetermined frequency; and/or
determining a navigation path between the roadside vehicles; and/or
determining a navigation path from the roadside vehicle to the destination.

11. The navigation method based on wayside reference object matching according to claim 10, wherein the step of searching in a second trip for a base point matched with any of the at least one wayside reference object comprises:
in the process of the subject required to reach the destination heading to the destination, photographing the license plates of the roadside vehicles for the second time; and
searching the license plates obtained during the photographing for the second time for the same license plates as the license plates obtained during the photographing for the first time.

12. The navigation method based on wayside reference object matching according to claim 11, wherein the vehicle is an electric vehicle, and the subject is a service person who delivers a valet charging service.

13. The navigation method based on wayside reference object matching according to claim 2, wherein the navigation method is a navigation method for a vehicle, and the wayside reference objects are license plates of roadside vehicles during a trip of the vehicle to the destination.

14. The navigation method based on wayside reference object matching according to claim 3, wherein the navigation method is a navigation method for a vehicle, and the wayside reference objects are license plates of roadside vehicles during a trip of the vehicle to the destination.

15. The navigation method based on wayside reference object matching according to claim 4, wherein the navigation method is a navigation method for a vehicle, and the wayside reference objects are license plates of roadside vehicles during a trip of the vehicle to the destination.

16. The navigation method based on wayside reference object matching according to claim 5, wherein the navigation method is a navigation method for a vehicle, and the wayside reference objects are license plates of roadside vehicles during a trip of the vehicle to the destination.

17. The navigation method based on wayside reference object matching according to claim 6, wherein the navigation method is a navigation method for a vehicle, and the wayside reference objects are license plates of roadside vehicles during a trip of the vehicle to the destination.

18. The navigation method based on wayside reference object matching according to claim 7, wherein the navigation method is a navigation method for a vehicle, and the wayside reference objects are license plates of roadside vehicles during a trip of the vehicle to the destination.
